(19) United States
(12) Patent Application Publication
(10) Pub. No.: US 2024/0304917 A1
(43) Pub. Date: Sep. 12, 2024

(54) METHOD OF MANUFACTURING BATTERY MODULE

(71) Applicant: SK ON CO., LTD., Seoul (KR)

(72) Inventors: Jae Hun KIM, Daejeon (KR); Yoon Sung OH, Daejeon (KR); Seul Gi LEE, Daejeon (KR); Seung Won LEE, Daejeon (KR); Min Jeong HONG, Daejeon (KR)

(21) Appl. No.: 18/583,879

(22) Filed: Feb. 22, 2024

(30) Foreign Application Priority Data
Mar. 6, 2023 (KR) 10-2023-0029501

(51) Int. Cl. H01M 50/211; H01M 10/04; H01M 50/186

(52) U.S. Cl. CPC H01M 50/211; H01M 10/049; H01M 50/186

(57) ABSTRACT

In a method of manufacturing a battery module, a plurality of battery cells each of which includes a pouch case including an inactive adhesive layer formed on an outer surface thereof and an electrode assembly accommodated in the pouch case are prepared. An energy is applied to the inactive adhesive layer of each of the battery cells to form an adhesive layer having an increased adhesion. The battery cells including the adhesive layer are stacked so that the adhesive layer is interposed between neighboring battery cells.

### CROSS-REFERENCE TO RELATED APPLICATION AND CLAIM OF PRIORITY

This application claims priority to Korean Patent Application No. 10-2023-0029501 filed on Mar. 6, 2023 in the Korean Intellectual Property Office (KIPO), the entire disclosure of which is incorporated by reference herein.

### BACKGROUND

### 1. Field

The disclosure of this patent document relates to a method of manufacturing a battery module. More particularly, the present disclosure relates to a method of manufacturing a battery module including a plurality of battery cells.

### 2. Description of the Related Art

A secondary battery capable of being charged and discharged has been actively researched according to developments of high-tech fields such as a digital camera, a smartphones, a laptop, a hybrid vehicle, etc. Examples of the secondary battery may include a nickel-cadmium battery, a nickel-metal hydride battery, a nickel-hydrogen battery, a lithium secondary battery, etc.

A lithium secondary battery has high operating voltage and energy density per unit weight, and has been used as a power source for portable electronic devices. Further, a plurality of lithium secondary batteries are connected to be applied to high-power hybrid vehicle and electric vehicle.

When the lithium secondary battery is used as a power source for a vehicle, a plurality of the secondary batteries may be connected to be used in the form of a battery module and a battery pack to increase a capacity and a power of the battery. To implement the battery module or the battery pack, various fastening components or cooling equipment are required.

However, the fastening components or the cooling equipment may increase a production cost, a volume and a weight of the battery module to reduce a power efficiency relative to the volume and the weight.

### SUMMARY

According to an aspect of the present disclosure, there is provided a method of manufacturing a battery module having improved productivity.

In a method of manufacturing a battery module according to embodiments of the present disclosure, a plurality of battery cells are prepared. Each of the battery cells includes a pouch case including an inactive adhesive layer formed on an outer surface thereof, and an electrode assembly accommodated in the pouch case. An energy is applied to the inactive adhesive layer of each of the battery cells to form an adhesive layer having an increased adhesion. The battery cells including the adhesive layer are stacked so that the adhesive layer is interposed between neighboring battery cells.

In some embodiments, in the preparation of the plurality of battery cells, the inactive adhesive layer may be formed on a pouch sheet. The pouch sheet on which the inactive adhesive layer is formed may be cut to form a plurality of the pouch cases. The electrode assembly may be accommodated in each of the pouch cases.

In some embodiments, in the formation of the inactive adhesive layer, a hot-melt adhesive may be coated entirely on an outer surface of the pouch sheet.

In some embodiments, in the accommodation of the electrode assembly, the electrode assembly may be sealed so that the inactive adhesive layer entirely surrounds the outer surface of the pouch case.

In some embodiments, in the formation of the inactive adhesive layer, a hot-melt adhesive may be discontinuously coated on an outer surface of the pouch sheet to form inactive adhesive layers spaced apart from each other. The pouch sheet may be cut so that a region between neighboring inactive adhesive layers of the inactive adhesive layers may be cut.

In some embodiments, in the accommodation of the electrode assembly, the electrode assembly may be sealed within the pouch case so that the inactive adhesive layer may be positioned on the outer surface of the pouch case.

In some embodiments, the electrode assembly may include an electrode tab protruding from a lateral surface.

In some embodiments, the inactive adhesive layer may not be formed on a sealing portion of the pouch case.

In some embodiments, in the preparation of the plurality of battery cells, an inactive adhesive sheet may be folded to entirely cover the outer surface of the pouch case in which the electrode assembly is accommodated.

In some embodiments, in the preparation of the plurality of battery cells, a hot-melt adhesive may be coated selectively on an accommodation portion of the pouch case in which the electrode assembly is accommodated. The coated hot-melt adhesive may be pressed by a pressure jig.

In some embodiments, the inactive adhesive layer may include a thermoplastic resin.

In some embodiments, the thermoplastic resin may include an ethylene vinyl acetate resin, a polyamide resin, a fatty acid polyamide resin, a polyester resin, a polyurethane resin, a polyolefin resin, a styrene-based resin, a rubber-based resin, etc. These may be used alone or in a combination of two or more therefrom.

In some embodiments, in the formation of the adhesive layer, the inactive adhesive layer may be heated to a temperature ranging from 20° C. to 100° C. for 1 minute to 30 minutes.

In a method for manufacturing a battery module according to embodiments of the present invention, an energy may be applied without peeling off a release paper to activate an adhesion. Thus, an adhesive layer between battery cells may be form by a further simpler process to reduce material disposal cost.

Additionally, a liquid adhesive may not be directly used in a stacking process of battery cells to prevent contamination of materials and facilities.

In the method of manufacturing the battery module according to example embodiments, supplement of a liquid adhesive or a double-sided tape may not be required during the stacking process. Thus, process line management cost and time may be reduced, and process operation ratio may be improved.

In some embodiments, an inactive adhesive layer may be used in a process of manufacturing a battery cell, and a battery cell stack may be manufactured without a process of additionally attaching the inactive adhesive layer.

### BRIEF DESCRIPTION OF THE DRAWINGS

FIG. 1 is a schematic flow diagram for describing a method of manufacturing a batter module in accordance with example embodiments.

FIGS. 2 to 5 are schematic views illustrating a method of preparing a battery cell in accordance with example embodiments.

FIGS. 6 and 7 are schematic views illustrating a method of manufacturing a battery module in accordance with example embodiments.

FIG. 8 is a schematic perspective view illustrating a battery module obtained by a method of manufacturing a battery module in accordance with example embodiments.

### DETAILED DESCRIPTION OF THE EMBODIMENTS

Hereinafter, embodiments of the present inventive concepts will be described in detail with reference to exemplary embodiments and the accompanying drawings. However, those skilled in the art will appreciate that such embodiments and drawings are provided to further understand the spirit of the present invention and do not limit subject matters to be protected as disclosed in the detailed description and appended claims.

The terms “top”, “bottom”, “upper”, “lower”, “one end”, “other end”, “on”, etc., used herein are intended to describe the relative positional relationship of elements and do not designate absolute positions. no.

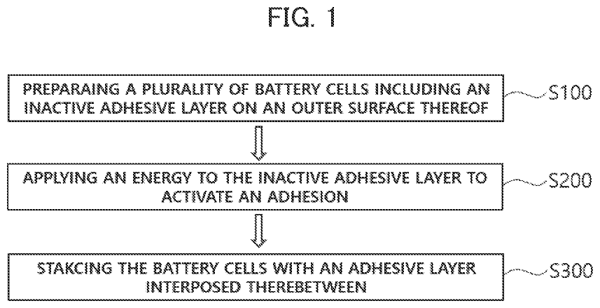

FIG. 1 is a schematic flow diagram for describing a method of manufacturing a batter module in accordance with example embodiments.

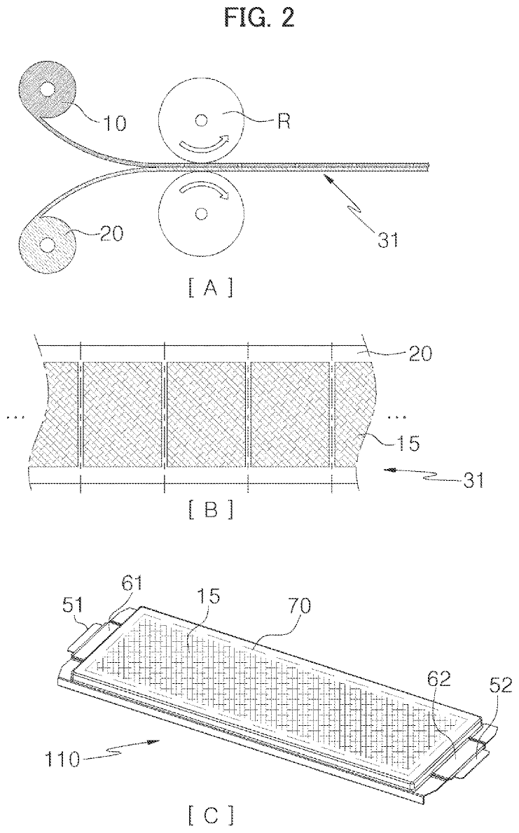

Referring to FIG. 1, a plurality of battery cells 110 (see FIG. 2) may be prepared. Each of the battery cells may include a pouch case having an inactive adhesive layer formed on an outer surface thereof, and an electrode assembly accommodated in the pouch case (e.g., in a phase of S100).

The term “outer surface” used herein refers to a surface exposed to an outside of the pouch case when a space in which the electrode assembly of the battery cell is accommodated is referred to as an inside.

The term “inactive adhesive layer” as used herein may refer to a precursor layer of an active adhesive layer in a state where an adhesive property is not activated, but the adhesive property is activated by an energy irradiation process as described later to be converted into an active adhesive layer.

The pouch case may be formed by sealing a pouch sheet. For example, the pouch sheet may have a multi-layered structure including an outer substrate layer, an intermediate substrate layer, a metal layer and an inner sealant layer which may be sequentially stacked. The inert adhesive layer may be formed on a surface of the outer substrate layer opposing a surface adjacent to the intermediate substrate layer.

The electrode assembly may include a plurality of electrodes. The electrodes may include cathodes and anodes which may be alternately and repeatedly stacked. The electrode assembly may further include a separator, and the cathode and the anode may be arranged to face each other with the separator interposed therebetween. For example, upper or lower surfaces corresponding to the widest surfaces of the cathode and the anode may face each other with the separator interposed therebetween.

In example embodiments, the electrode assembly may include electrode tabs 61 and 62 (see FIG. 2) protruding from a lateral surface. The lateral surface may refer to a side in a direction perpendicular to a direction in which the pouch case of the battery cell surrounds the electrode assembly.

The electrodes of the electrode assembly and electrode leads (a cathode lead 51 and an anode lead 52) may be electrically connected to each other via the electrode tabs. A cathode tab portion may protrude from each of the cathode, and an anode tab portion may protrude from each of the anodes. The cathode tab portions may be fused together with the cathode lead 51 to form a cathode tab 61, and the anode tab portions may be fused together with the anode lead 52 to form an anode tab 62.

In some embodiments, the battery cell 110 may further include an electrolyte solution accommodated together with the electrode assembly in the pouch case.

The inactive adhesive layer 15 may be formed on a partial area or an entire area of the outer surface of the pouch case. When the inactive adhesive layer 15 is formed on the partial area on the outer surface of the pouch case, the inactive adhesive layer 15 may be formed on an area corresponding to an area of the electrode assembly (e.g., an accommodation portion 70 of the pouch case). In one embodiment, the inactive adhesive layer 15 may be formed on an area corresponding to an area of the widest surface of the electrode assembly.

When an energy is applied to the inactive adhesive layer 15, the adhesive property of the inactive adhesive layer 15 may be increased. Before the energy is applied, the inactive adhesive layer 15 may have a relatively low adhesion. Accordingly, the battery cell 110 on which the inactive adhesive layer 15 is formed may be easily stored before performing a battery cell stacking process as described later or easily transferred to the battery cell stacking process.

The inactive adhesive layer 15 may include a hot-melt adhesive. For example, the inactive adhesive layer 15 may be formed from an inactive adhesive sheet containing the hot-melt adhesive.

The hot-melt adhesive may include a thermoplastic resin. The thermoplastic resin may be melted at a temperature greater than or equal to a melting point, and may be solidified by cooling to have a variable adhesiveness depending on a temperature.

For example, the inactive adhesive layer may be formed by cooling a heated thermoplastic resin in a liquid state. The inactive adhesive layer may not be melted under a condition below the melting point and thus does not have the adhesiveness. However, when energy is applied in a subsequent process, the inactive adhesive layer may provide an adhesiveness under a temperature condition greater than or equal to the melting point. After the completion of the process, the inactive adhesive layer may be cooled again below the melting point to fixe or adhere the objects.

The thermoplastic resin may include, e.g., an ethylene vinyl acetate resin, a polyamide resin, a fatty acid polyamide resin, a polyester resin, polyurethane resin, a polyolefin resin, a styrene-based resin, a rubber-based resin, etc. These may be used alone or in a combination of two or more therefrom.

The inert adhesive layer may include a flame retardant. For example, the flame retardant may include a phosphorus-based flame retardant and/or a nitrogen-based flame retardant.

In some embodiments, the phosphorus-based flame retardant may include a phosphate compound, a phosphonate compound, a phosphinate compound, a phosphine oxide compound, a phosphazene compound, a metal salt thereof, etc. These may be used alone or in a combination of two or more therefrom.

Non-limiting examples of the phosphorus-based flame retardant include diphenyl phosphate, diaryl phosphate, triphenyl phosphate, tricresyl phosphate, trixyrenyl phosphate, tri(2,6-dimethylphenyl) phosphate, tri(2,4,6-trimethylphenyl)phosphate, tri(2,4-ditertibutylphenyl)phosphate, tri(2,6-dimethylphenyl)phosphate, bisphenol-A bis(diphenylphosphate), resorcinol bis(diphenylphosphate), resorcinol bis[bis(2,6-dimethylphenyl)phosphate], resorcinol bis[bis(2,4-di-tert-butylphenyl)phosphate], hydroquinone bis[bis(2,6-dimethylphenyl)phosphate], hydroquinone bis[bis(2,4-di-tert-butylphenyl)phosphate], an oligomeric phosphoric acid ester-based compound, etc. These may be used alone or in a combination of two or more therefrom.

The nitrogen-based flame retardant may include, e.g., melamine or a melamine derivative. These may be used alone or in a combination of two or more therefrom.

Non-limiting examples of the nitrogen-based flame retardant may include melamine, melamine phosphate, melamine cyanate, etc. These may be used alone or in a combination of two or more therefrom.

In example embodiments, a thickness of the inactive adhesive layer 15 may be in a range from, e.g., 10 μm to 500 μm, but is not limited thereto.

In example embodiments, the inactive adhesive layer 15 may be formed on the pouch sheet, and then may be cut to prepare a plurality of the pouch cases.

In some embodiments, a hot-melt adhesive may be coated on the outer surface of the pouch sheet to form the inactive adhesive layers 15. In one embodiment, an inactive adhesive sheet including the hot-melt adhesive may be attached to the outer surface of the pouch sheet to coat the hot-melt adhesive. In one embodiment, an adhesive composition including the hot-melt type adhesive may be applied on the outer surface of the pouch sheet, and then cured and/or dried to coat the hot-melt adhesive.

FIG. 2 is a schematic view for describing a method of manufacturing a battery cell in accordance with some embodiments.

Referring to [A] and [B] of FIG. 2, an inactive adhesive sheet 10 may be attached on a pouch sheet 20 using a pressure roll R to prepare a pouch sheet 31 having the inactive adhesive layer formed thereon may.

The inactive adhesive sheet 10 may be discontinuously attached to an outer surface of the pouch sheet 20. Accordingly, as illustrated in [B] of FIG. 2, inactive adhesive layers 15 may be spaced apart from each other on the outer surface of the pouch sheet 20.

A region between neighboring inactive adhesive layers of the pouch sheet 31 having the inactive adhesive layers 15 discontinuously formed thereon may be cut. For example, the pouch sheet 31 may be cut along dotted lines indicated in [B] of FIG. 2. A plurality of pouch cases may be formed using the cut pouch sheet 31.

Referring to [C] in FIG. 2, the electrode assembly may be accommodated in each of the pouch cases to manufacture a battery cell 110 including the inactive adhesive layer 15 formed thereon.

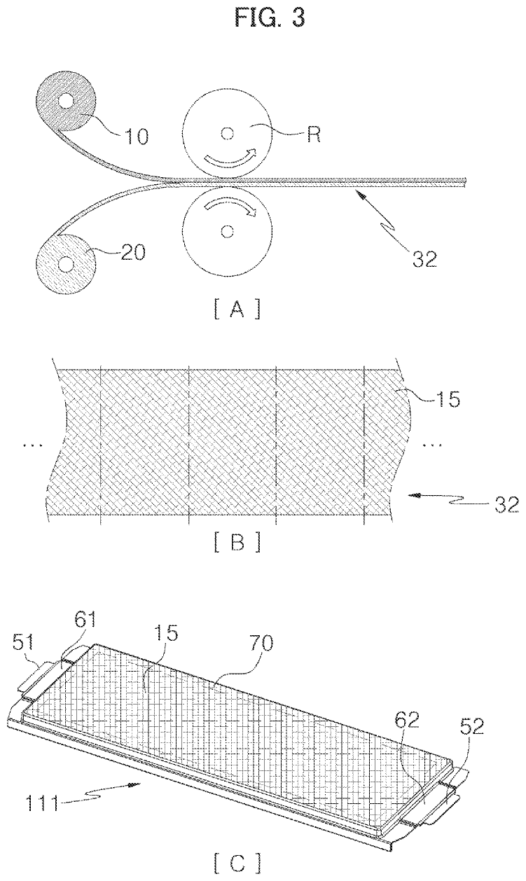

FIG. 3 is a schematic view for describing a method of manufacturing a battery cell in accordance with some embodiments.

Referring to [A] and [B] of FIG. 3, the inert adhesive sheet 10 may be attached to the entire outer surface of the pouch sheet 20 using the pressure roll R to prepare a pouch sheet 32.

The inactive adhesive sheet 10 may be continuously attached to the outer surface of the pouch sheet 20. As illustrate in [B] of FIG. 3, the inactive adhesive layer 15 may be formed on the entire outer surface of the pouch sheet 20.

The pouch sheet 32 on which the inert adhesive layer is entirely formed may be cut to prepare the pouch case. For example, the pouch sheet 32 may be cut along dotted lines indicated in [B] of FIG. 3. A plurality of pouch cases may be formed by using the cut pouch sheet 32.

Referring to [C] of FIG. 3, the electrode assembly may be accommodated in each of the pouch cases to obtain a battery cell 111 on which the inactive adhesive layer 15 is formed. For example, the electrode assembly may be sealed in the pouch case so that the inactive adhesive layer 15 may entirely surrounds the outer surface of the pouch case. Accordingly, the inactive adhesive layer 15 may be exposed to the outer surface of the battery cell 111, and the battery cells 111 may be attached to each other by energy application and stacking processes as will be described later.

In some embodiments, the inactive adhesive layer 15 may not be formed on a sealing portion of the pouch case. The sealing portion may refer to a portion where the pouch case is fused after accommodating the electrode assembly in the fabrication of a pouch-type battery cell.

In some embodiments, an adhesive composition including the hot-melt adhesive may be applied on the outer surface of the pouch sheet, and cured and/or dried to form the inactive adhesive layer.

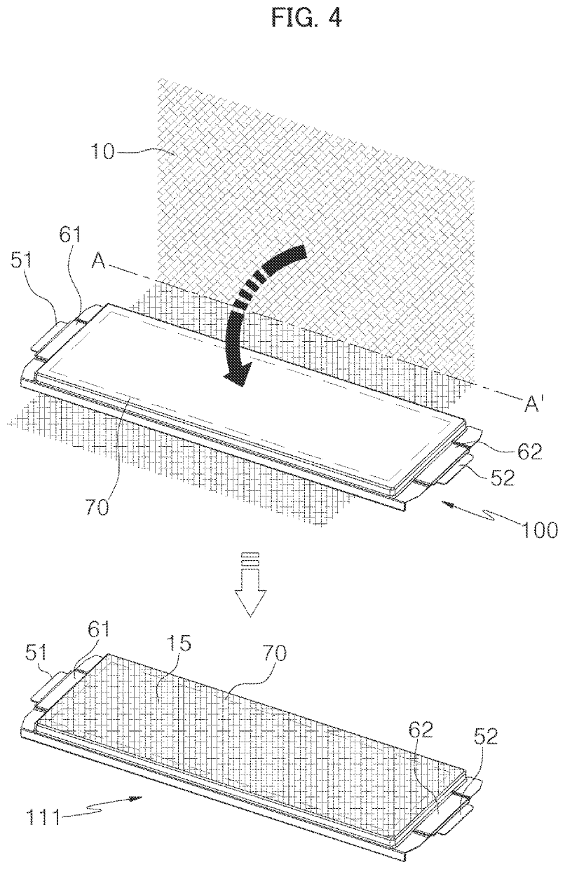

FIG. 4 is a schematic view for describing a method of manufacturing a battery cell in accordance with some embodiments.

Referring to FIG. 4, the inactive adhesive sheet 10 may be folded in a direction indicated by an arrow along a dotted line A-A′. Accordingly, the inactive adhesive layer 15 may be formed to entirely surround the outer surface of the battery cell 100 (the battery cell before forming the inactive adhesive layer) which includes the pouch case accommodating the electrode assembly. Accordingly, the battery cell 111 including the inactive adhesive layer 15 may be prepared.

The inert adhesive sheet 10 may be used in a state of being cut to have an area of more than twice an area of one surface of the battery cell 100.

In example embodiments, a plurality of battery cells having an inactive adhesive layer may be prepared by selectively coating the hot-melt adhesive on an accommodation portion of the pouch case in which the electrode assembly is accommodated and pressing by a pressure jig.

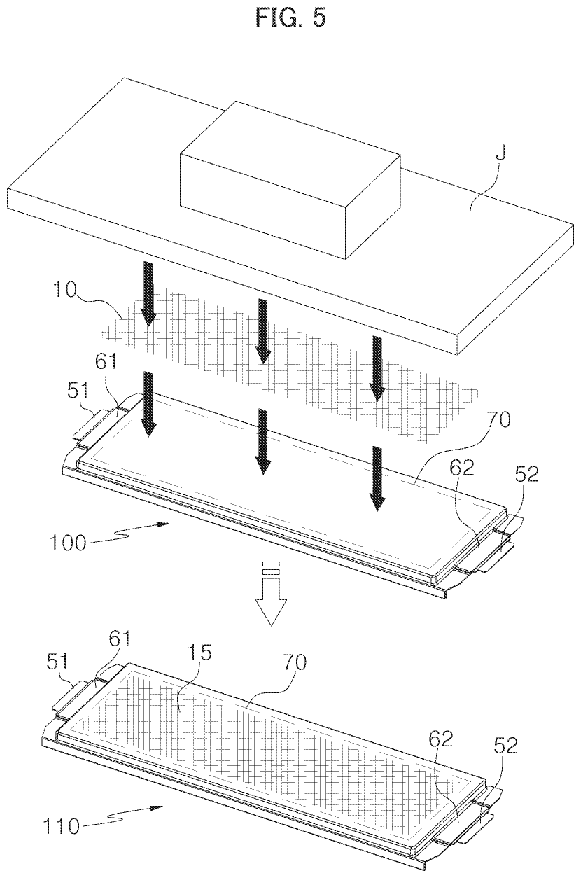

FIG. 5 is a schematic view for describing a method of manufacturing a battery cell in accordance with to some embodiments.

Referring to FIG. 5, the inactive adhesive sheet 10 may be selectively on an accommodation portion 70 of the battery cell 100 (the battery cell before forming the inactive adhesive layer) that includes the pouch case that accommodates the electrode assembly, and then pressed as indicated by arrows using a pressure jig J to obtain the battery cell 110 having the inactive adhesive layer 15.

For convenience of descriptions, FIG. 5 illustrates that the inactive adhesive sheet 10 is compressed in a state of being spaced apart from the battery cell 100, but the inactive adhesive sheet 10 may be compressed in a state of being in contact with the surface of the battery cell 100.

In example embodiments, an adhesive composition including the hot-melt adhesive may be applied on the accommodation portion 70 of the pouch case for accommodating the electrode assembly, and then cured and/or dried to form the inactive adhesive layer 15.

The term “accommodating portion” may refer to a region on the outer surface of the pouch case corresponding to an upper surface region of the electrode assembly.

A plurality of the battery cells 110 having the inactive adhesive layer 15 may be manufactured by the above-described method. A battery module may include a plurality of the battery cells that may be stacked for obtaining a high capacity. The number of battery cells 110 included in the battery module may be adjusted depending on the application object and purpose of the battery module.

Referring again to FIG. 1, an energy may be irradiated to the inactive adhesive layer 15 of each of the battery cells 110 to form an active adhesive layer (e.g., in a phase of S200). When the energy is applied, an adhesion of the inactive adhesive layer 15 may be activated, and may be converted into the active adhesive layer.

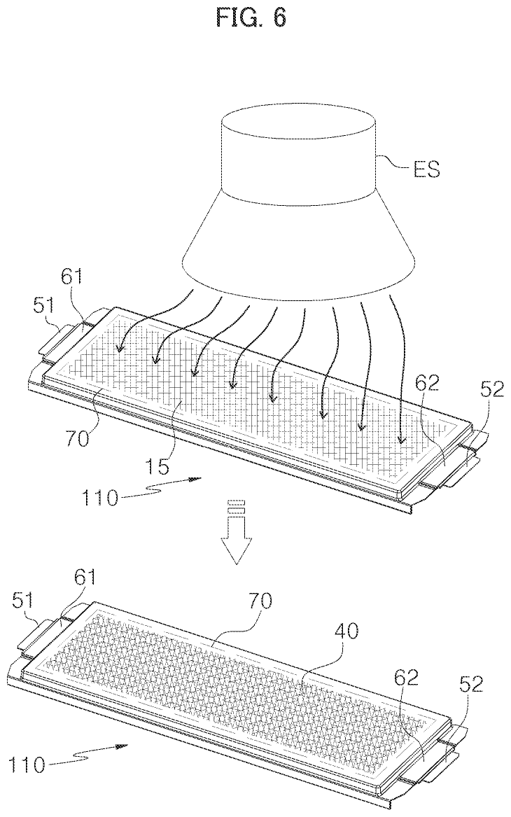

FIG. 6 is a schematic view for describing a conversion into an active adhesive layer in accordance with example embodiments.

Referring to FIG. 6, an energy may be applied to the inactive adhesive layer 15 on the outer surface of the battery cell 110 using an energy source ES. The inactive adhesive layer 15 may be converted into an active adhesive layer 40 in a state capable of attaching another battery cell. Accordingly, the battery cell 120 having the active adhesive layer 40 may be formed.

The energy application may be performed until a temperature of a surface of the inactive adhesive layer 15 reaches a specific temperature. In one embodiment, the specific temperature above may be in a range from 20° C. to 100° C. In one embodiment, the specific temperature above may be in a range from 60° C. to 100° C. The energy may be applied until reaching the specific temperature, so that the adhesion of the inactive adhesive layer 15 may be activated.

The energy may include a thermal energy and/or a light energy. In example embodiments, the inactive adhesive layer 15 may be directly heated using a heat source or heated using a light source. A energy application time may be in a range from 1 minute to 30 minutes.

Referring again to FIG. 1, after the activation of the adhesion, the battery cells 110 having the active adhesive layer 40 may be stacked with the active adhesive layer 40 interposed therebetween (e.g., in a phase of S300).

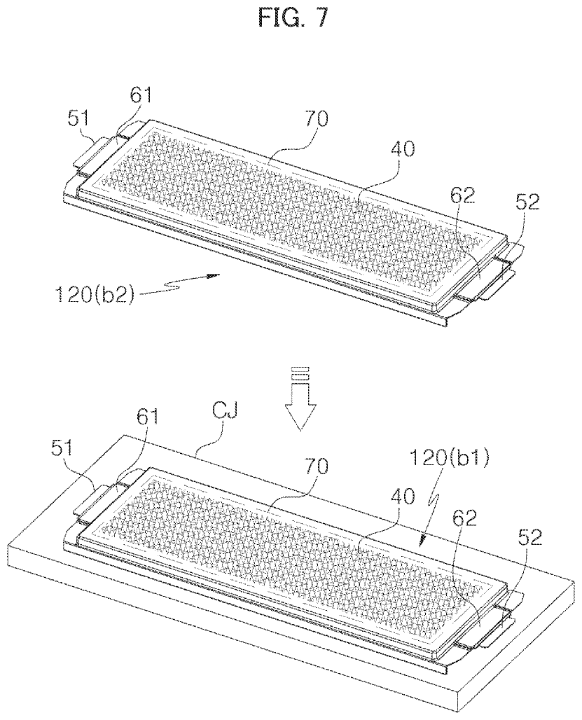

FIG. 7 is a schematic view for describing a process of stacking battery cells in accordance with example embodiments.

Referring to FIG. 7, a first battery cell 120(b1) having the active adhesive layer 40 may be mounted on a cell stack jig CJ. Thereafter, a second battery cell 120(b2) which is another cell having the active adhesive layer 40 may be stacked on the active adhesive layer 40 of the first battery cell 120(b1).

The above-described stacking process may be repeated to obtain the battery module including a plurality of the battery cells 110 may be manufactured.

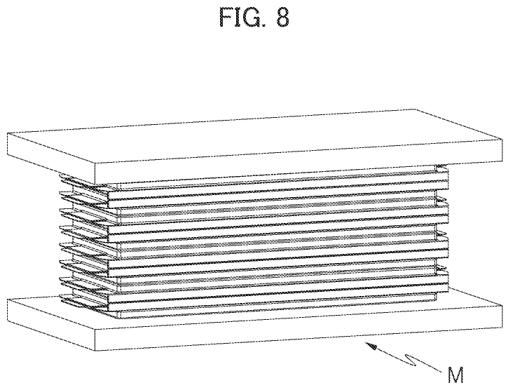

FIG. 8 is a schematic view of a battery module M manufactured by the method of manufacturing a battery module in accordance with example embodiments.

In example embodiments, the process of applying the energy (e.g., the phase of S200 in FIG. 1) and the stacking process (e.g., the phase of S300 in FIG. 1) may be repeated for each of the plurality of battery cells 110.

In one embodiment, the energy may be applied to all of the inactive adhesive layers 15 of the pouch-type battery cells 110 each having the inactive adhesive layer 15 to activate the adhesion. Accordingly, the battery cells 110 having the active adhesive layers may be sequentially stacked to form the battery module M. In this case, efficiency of the fabrication of the battery module may be enhanced.

In one embodiment, the adhesion may be activated by applying the energy to the inactive adhesive layer 15 of one battery cell 110, and then the other battery cell 110 may be stacked. Thereafter, the activation of the adhesion with respect to the other battery cells 110 and the stack of another battery cell 110 may be repeated to form the battery module M. In this case, the adhesion between the battery cells 110 may become substantially uniform, and overall durability of the battery module M may also become uniform.

The battery module M manufactured according to embodiments of the present disclosure as described above may be widely used in various devices requiring electrical storage such as an energy storage system (ESS) including an electric vehicle.

What is claimed is:

1. A method of manufacturing a battery module, comprising:
preparing a plurality of battery cells, wherein each of the battery cells comprises:
a pouch case including an inactive adhesive layer formed on an outer surface thereof; and
an electrode assembly accommodated in the pouch case;
applying an energy to the inactive adhesive layer of each of the battery cells to form an adhesive layer having an increased adhesion; and
stacking the battery cells including the adhesive layer so that the adhesive layer is interposed between neighboring battery cells.

2. The method of claim 1, wherein preparing the plurality of battery cells comprises:
forming the inactive adhesive layer on a pouch sheet;
cutting the pouch sheet on which the inactive adhesive layer is formed to form a plurality of the pouch cases; and
accommodating the electrode assembly in each of the pouch cases.

3. The method of claim 2, wherein forming the inactive adhesive layer comprises coating a hot-melt adhesive entirely on an outer surface of the pouch sheet.

4. The method of claim 3, wherein accommodating the electrode assembly comprises sealing the electrode assembly so that the inactive adhesive layer entirely surrounds the outer surface of the pouch case.

5. The method of claim 2, wherein forming the inactive adhesive layer comprise discontinuously coating a hot-melt adhesive on an outer surface of the pouch sheet to form inactive adhesive layers spaced apart from each other, and
cutting the pouch sheet comprises cutting a region between neighboring inactive adhesive layers of the inactive adhesive layers.

6. The method of claim 5, wherein accommodating the electrode assembly comprises sealing the electrode assembly within the pouch case so that the inactive adhesive layer is positioned on the outer surface of the pouch case.

7. The method of claim 6, wherein the electrode assembly comprises an electrode tab protruding from a lateral surface.

8. The method of claim 6, wherein the inactive adhesive layer is not formed on a sealing portion of the pouch case.

9. The method of claim 1, wherein preparing the plurality of battery cells comprises folding an inactive adhesive sheet to entirely cover the outer surface of the pouch case in which the electrode assembly is accommodated.

10. The method of claim 1, wherein preparing the plurality of battery cells comprises:
selectively coating a hot-melt adhesive on an accommodation portion of the pouch case in which the electrode assembly is accommodated; and
pressing the coated hot-melt adhesive by a pressure jig.

11. The method of claim 1, wherein the inactive adhesive layer includes a thermoplastic resin.

12. The method of claim 11, wherein the thermoplastic resin includes at least one selected from the group consisting of an ethylene vinyl acetate resin, a polyamide resin, a fatty acid polyamide resin, a polyester resin, a polyurethane resin, a polyolefin resin, a styrene-based resin and a rubber-based resin.

13. The method of claim 1, wherein forming the adhesive layer comprises heating the inactive adhesive layer to a temperature ranging from 20° C. to 100° C. for 1 minute to 30 minutes.
